(19) United States
(12) Patent Application Publication
(10) Pub. No.: US 2025/0278267 A1
(43) Pub. Date: Sep. 4, 2025

(54) ASSESSING MICROSERVICE SYSTEM EVOLUTION THROUGH QUANTITATIVE REASONING

(71) Applicants: Arizona Board of Regents on Behalf of the University of Arizona, Tucson, AZ (US); Baylor University, Waco, TX (US)

(72) Inventors: Tomas CERNY, Tucson, AZ (US); Amr Elsayed Mohamed Abdelfattah Saad AISHA, Waco, TX (US); Jorge YERO, Waco, TX (US)

(21) Appl. No.: 19/066,515

(22) Filed: Feb. 28, 2025

Related U.S. Application Data
(60) Provisional application No. 63/560,590, filed on Mar. 1, 2024.

(51) Int. Cl. G06F 8/71; G06F 8/75

(52) U.S. Cl. CPC G06F 8/71; G06F 8/75

(57) ABSTRACT

Methods and systems for tracking the evolution of a microservice system are described. An example method includes generating, based on an analysis of a source code of the microservice system, an intermediate representation associated with a service view or a data model view of the microservice system. The method further includes determining, based on the intermediate representation, (i) a first set of values for multiple metrics associated with a first version of the source code, and (ii) a second set of values for the multiple metrics associated with a second version of the source code. The method further includes generating, based on comparing the first set of values and the second set of values, an output comprising an analysis of one or more architectural changes in the microservice system. An example system includes one or more processors configured to implement the above-described method.

### CROSS-REFERENCE TO RELATED APPLICATION

This patent document claims priority to and benefits of U.S. Provisional Patent Application No. 63/560,590, entitled “ASSESSING MICROSERVICE SYSTEM EVOLUTION THROUGH QUANTITATIVE REASONING,” and filed on Mar. 1, 2024. The entire content of the before-mentioned patent application is incorporated by reference as part of the disclosure of this patent document.

### TECHNICAL FIELD

This patent document generally related to microservice systems, and more particularly, to assessing the evolution of microservice systems.

### BACKGROUND

Microservices are an architectural and organizational approach to software development where software is composed of small independent services that communicate over well-defined APIs. These services are owned by small, self-contained teams. Microservices architectures make applications easier to scale and faster to develop, enabling innovation and accelerating time-to-market for new features.

### SUMMARY

Microservices gained significant traction in enterprise software systems due to their ability to encapsulate knowledge for specific organizational subunits, offering insights into underlying processes and communication pathways. The advantage of microservices lies in their self-contained nature, streamlining management and deployment. However, this decentralized approach scatters knowledge across microservices, and as these systems continually evolve, substantial changes may affect not only individual microservices but the entire system. This dynamic environment increases the complexity of system maintenance, emphasizing the need for centralized assessment methods to analyze these changes. The described embodiments introduce quantification metrics to serve as indicators for investigating system architecture evolution and reasoning about changes across different system versions. They focus on two holistic viewpoints of inter-service interaction and data modeling perspectives derived through static analysis of the system's source code. The approach is validated with a case study using established microservice system benchmarks.

In an example aspect, a method of tracking an evolution of a microservice system that includes a plurality of microservices is disclosed. The method begins with generating, based on an analysis of a source code of the microservice system, an intermediate representation associated with a service view or a data model view of the microservice system. The method further includes determining, based on the intermediate representation, a first set of values for a plurality of metrics associated with a first version of the source code, and determining, based on the intermediate representation, a second set of values for the plurality of metrics associated with a second version of the source code. Finally, the method includes generating, based on comparing the first set of values and the second set of values, an output comprising an analysis of one or more architectural changes in the microservice system.

In another example aspect, a system for tracking an evolution of microservice systems is disclosed. The system includes one or more processors and a microservice system that includes a plurality of microservices that interact to perform an overall application function, each microservice of the plurality of microservices being associated with at least one endpoint and configured to perform a partial function of the overall application function, and the at least one endpoint of a corresponding microservice enabling a user or another microservice to interact with the corresponding microservice. In this system, the one or more processors are configured to generate, based on an analysis of a source code of the microservice system, an intermediate representation associated with a service view or a data model view of the microservice system. Then, the one or more processors determine, based on the intermediate representation, a first set of values for a plurality of metrics associated with a first version of the source code, and determine, based on the intermediate representation, a second set of values for the plurality of metrics associated with a second version of the source code. Finally, the one or more processors generate, based on comparing the first set of values and the second set of values, an output comprising an analysis of one or more architectural changes in the microservice system.

In yet another example aspect, an apparatus comprising a memory and a processor that implements the above-described method is disclosed.

In yet another example aspect, the above-described method may be embodied as processor-executable code and may be stored on a non-transitory computer-readable program medium.

The above and other aspects and features of the disclosed technology are described in greater detail in the drawings, the description and the claims.

### BRIEF DESCRIPTION OF THE DRAWINGS

FIG. 1A illustrates an example of a component call graph (CCG).

FIG. 1B illustrates an example of constructing service and data model views.

FIG. 2 illustrates an example of a microservice system that includes persistent data entities and transient data entities.

FIG. 3 illustrates an example of merging entities in the example microservice system shown in FIG. 2.

FIG. 4 illustrates an example of the evolution of metrics across versions of the Train-Ticket Testbench.

FIGS. 5A-5C illustrate examples of the service view visualization of the intermediate representation for different versions of the Train-Ticket Testbench.

FIGS. 6A-6C illustrate examples of the context map visualization of the intermediate representation for different versions of the Train-Ticket Testbench.

FIGS. 7A and 7B illustrate an example of duplicating entities in a different contexts of the Train-Ticket Testbench microservice system.

FIG. 8A illustrates a heat matrix depicting the number of dependency connections between pairs of microservices.

FIG. 8B illustrates another heat matrix depicting the relationships between data entities, and identification of merge candidates among microservices.

FIG. 9 illustrates a flowchart of an example method of tracking an evolution of a microservice system that includes multiple microservices.

FIG. 10 is a block diagram illustrating an example system configured to implement embodiments of the disclosed technology.

### DETAILED DESCRIPTION

Devices, systems, and methods for assessing microservice system evolution through quantitative reasoning are described. Section headings are used in the present document to improve readability of the description and do not in any way limit the discussion or the embodiments (and/or implementations) to the respective sections only.

### 1. Introduction

Microservice architecture is commonly employed in complex systems, facilitating selective scalability and decomposing intricate organizational structures into smaller, independently managed units. These units are then overseen by separate development teams. In the realm of software systems, evolution is inevitable, driven by various factors such as new market demands, technological shifts, and optimization efforts. This evolutionary process often involves implementing new features, resolving bugs, and potentially introducing new services with their respective data models and system dependencies.

However, due to the decentralized nature of this evolution, spread across semi-autonomous teams, a holistic system-centric perspective is often lost. Moreover, individual teams may inadvertently make suboptimal design choices, leading to inefficiencies that affect the overall system. Consequently, system architecture may degrade over changes as system complexity increases.

To address these challenges, specifically the absence of a system-centered view and the lack of assessment and reasoning approaches in system evolution, we propose constructing a centralized perspective of the system's architecture. This perspective is generated by aggregating views from each microservice, considering them as operating within their respective bounded contexts.

Given that software architecture can encompass varying interpretations among experts, different viewpoints are typically considered. Software Architecture Reconstruction (SAR) produces multiple views and perspectives of the system. Several such views have been introduced for the microservice architecture, including the following:
Service View: It constructs service models specifying microservices, endpoints, and interactions, which should be an essential view in the system's holistic view. It aids in assessing potential ripple effects during their evolution.
Domain View: It addresses domain expert concerns through domain and data models and microservice bounded contexts.
Technology View: It identifies the technologies applied in microservices.
Operation View: It pertains to the topology for service deployment and operational concerns.

Embodiments of the disclosed technology provide central metrics for microservice-based systems. These metrics serve as quantifications for the centralized viewpoints of the system. They aid in the process of reasoning about the system's evolution over changes. Additionally, the described methods are extended to visualize these viewpoints of microservice-based systems to investigate their utility in the context of system evolution and reasoning about design changes across version snapshots. This patent document addresses the following questions:
Q₁ How can architectural viewpoints help to reason about the architectural evolution of microservice systems?
Q_{1.1} How to quantify architectural viewpoints through source code-based metrics? Specifically, how can the service viewpoint and the data viewpoint (and their corresponding evolution) be quantified?
Q_{1.2} How to visualize the evolution of these architectural viewpoints?

This patent document includes a comprehensive case study with a practical application of the proposed metrics in the context of system evolution analysis. The case study employs a variety of approaches to demonstrate the underlying reasons driving the evolution of systems across various releases.

Embodiments of the disclosed technology provide, inter alia, the following benefits, contributions, and/or advantages:
System-centric metrics tailored specifically for microservice architectures are introduced and defined. Unlike traditional metrics, which often focus on monolithic systems or lack granularity for microservices, these metrics provide a new way to quantify key architectural properties such as service granularity. This advances the current understanding of microservice system behavior, helping to bridge a gap in the existing literature.
Automated methods for extracting the proposed metrics directly from the system's source code were developed and implemented. This methodological advancement allows for the efficient, repeatable, and scalable analysis of microservice-based architectures, enabling researchers and practitioners to assess systems without extensive manual intervention. The use of automation also opens up new pathways for continuous monitoring and checking of system health.
A Java-based prototype was developed as a practical tool for calculating and reporting these metrics. This prototype can be integrated into development pipelines, providing indicators about the system architecture that can influence architectural decisions and system improvements.
A dataset containing the extracted metrics data, which captures insights from both service and domain viewpoints of a benchmark system, has been published. This dataset provides a valuable resource for further research, enabling other scholars to replicate and extend our study or apply the metrics to different microservice systems.
A comprehensive case study was conducted to evaluate and interpret the extracted metrics. This empirical investigation not only validates the usefulness of the metrics but also provides evidence-based insights into how these metrics can be applied in realistic scenarios, contributing to the body of knowledge on microservice architecture assessment.
A visualization approach to display architectural views from both service and data viewpoints has been developed. This visualization is essential for understanding and reasoning about the relationship between different microservices in the system, offering a new way to analyze and optimize microservice architectures.

Decentralized system evolution could be seen as an uncontrolled process, where changes pushed to a single microservice codebase lack awareness of the impact on other microservices. If developers and reviewers could analyze local microservice change's impact on the overall system, they would likely prevent ripple effects, coordinate such changes with relevant teams, and perform trade-off analysis to maintain the system architecture quality. With assumed access to system microservice codebases and version control, managed microservice dependencies could be used as pathways of potential change propagation. However, changes must be quantified to appropriate components in the source code and connected with relevant pathways. Moreover, not all pathways are necessarily involved, and thus, reliable algorithms should indicate routes involved in the particular change. A tool pointing on a change impact will advance the maintainability of cloud-native systems. The disclosed embodiments provide methods and systems that address these issues, and provide tools for change impact analysis, as described in this patent document.

The evolution of microservice architecture brings up multifaceted challenges across various dimensions of the system. To proactively identify and mitigate potential errors, gaining a comprehensive understanding of how the system evolves with each change becomes imperative. Consequently, multiple studies have introduced diverse approaches and metrics aimed at comprehending the system and its intricate perspectives.

Several studies have introduced SAR techniques that enable the extraction of viewpoints from the system. Existing implementations employ static analysis coupled with reflection modeling to create a high-level model that depicts architectural components and data/control flows, analyze Docker configurations to grasp the microservice deployment topology, providing insights into component interactions, and/or combine static and dynamic analysis to furnish both static and dynamic viewpoints, facilitating comprehensive architecture reconstruction.

However, while these studies have proposed approaches to reconstruct different system perspectives, they often overlook the critical aspect of system evolution. For instance, some implementations address system evolution by considering snapshots of the current architecture, yet they do not consider the dynamic evolution of microservices over time. Other implementations propose an approach that leverages both static and dynamic information to generate a representation of evolving microservice-based systems based on service evolution modeling.

The evolution of microservice architecture significantly impacts the cohesion and coupling of system components. Several studies have introduced metrics designed to assess these critical features of the system. For instance, some existing systems emphasize metrics at both the individual service level and in aggregate. These metrics delve into the frequency of interactions between microservices, patterns of relationships formed through these interactions, the equilibrium of dependencies across services, and the significance of each service within the architecture. Meanwhile, other existing systems propose three metrics that focus on the internal perspective of services, assessing aspects such as the consistency in parameters and return types across exposed interfaces, internal cohesion based on inputs and outputs, and the overall cohesion within a service reflecting unity in its operational implementations.

On the other hand, visualization plays a crucial role in conveying the evolution to human experts, enabling them to analyze and reason effectively. Existing systems have introduced MicroDepGraph, a tool presenting connected services and plotting the dependency graph of microservices, but which lacks the ability to distinguish different service types effectively. Other existing systems have proposed a virtual reality (VR) solution for immersive visualization of large-scale enterprise system architecture, introduced a 3D augmented reality method for microservice data visualization, enhancing scalability and navigation, and/or demonstrated dependency matrix visualization for showcasing service and data dependencies among microservices pairs in the system. These visualizations are essential for human experts to comprehend the evolution of microservice architectures.

The proposed methods in existing literature have limitations when it comes to reconstructing abstract system-centric views directly from the source code. The disclosed embodiments present the construction and utilization of these views, which are subsequently visualized and mined to extract comprehensive metrics that provide an insightful perspective on the entire system. This approach enables a more profound understanding of microservice architecture evolution and enhances the capacity for reasoning about it.

### 2. Examples of System-Centric Metrics

The evolution of the system's architecture is a direct consequence of the modifications made to the source code. As a result, analyzing architecture evolution provides a timeline of the system's development. This timeline is instrumental in comprehending the motives behind the modifications and the broader impact of these changes.

Context: Source code modifications predominantly influence both the service and domain views. The addition or removal of microservices, endpoints, and inter-service calls significantly impacts the service view. Furthermore, an examination of the data model highlights the duplication of data items within different bounded contexts of microservices. Notably, the presence of multiple data item duplications in various microservices signifies a coupling between those services.

Objective: This methodology introduces seven metrics aimed at quantifying changes within the service view and the data model of the domain view. These metrics serve as indicators of the system's main development stream and offer early insights into potential architectural degradation. Moreover, these metrics provide a centralized explanation of system properties. They can be tracked across different versions of the system to ensure that system properties align with the changes made in each version. Practitioners can create a timeline of these metrics, illustrating how system attributes evolve across various versions. Additionally, this approach offers visual representations of both viewpoints, annotating the reasoning process for practitioners and enabling them to visually investigate specific aspects of the system from a centralized perspective.

### A. Intermediate Representation Overview

Embodiments of the disclosed technology provide the detection of the various dependency types, and determine the extent to which such dependencies can be detected or approximated by automated means.

For example, the control-flow perspective of systems to detect explicit remote calls across services are considered. The disclosed embodiments identify endpoints from all individual microservices and also the remote calls issues by microservices analyzing high-level constructs. Endpoint signatures are then matched to identified remote calls to extract a service dependency graph. However, it must be noted that such matching leads to approximation since remote call parameter types might be difficult to identify. At the same time, current technologies do not support endpoint overload, which addresses the limitation. Next, the detection of microservice interaction is enabled through message queues (i.e., Kafka) and event-driven interaction across the middleware and detect configuration files for setting up message queues and in-memory distributed databases (i.e., Redis). The control-flow perspective provides the initial dependencies for the dependency management.

To further advance dependency management, the data persistence and data-flow perspectives are considered. It has been previously demonstrated that data entity structures can be detected and used for structural similarity assessment across microservices to uncover the context map of the system (canonical data model). Such an approach could be further broadened and promoted to include data transfer objects used for data exchange and data transformations. Other embodiments include data constraints, which could be managed since their inconsistency could lead to data loss or data rejection. However, it must be noted that data structure similarity leads to approximation. To validate matching data entity structure similarity, candidates' control-flows can be used since these microservices likely interact.

To integrate clones into the dependency management, existing tools could be used in microservices. Utilizing clones as dependencies could have a deeper cause of restated concerns. For instance, policy definitions cannot be reused across microservices because of limited modularization, which would not constrain the decentralized environment. One could argue that shared rules could be injected as a shared library, but then we would design a distributed monolith, losing the benefits of independent microservice deployment and evolution. Such a shared rule using a library would gain the status of a technology equivalent. To this end, the disclosed embodiments ensure that each microservice defines its own knowledge set. This relates to business logic, processes, or even authorization rules. Tracking such dependencies further augment the system's holistic perspective and provide an instrument to analyze changes. However, the problem of identifying such knowledge might be extremely complex when using general-purpose language constructs; a viable path is the use of high-level constructs and components that capture additional descriptors. To this end, the disclosed embodiments enable authorization rules to be appended to endpoints (i.e., XML descriptor, annotation, etc.). Thus, the use of higher-level constructs enable pathways for dependency management.

The diversity across microservices could become a challenge when dealing with syntactic clones, and to cope with such situations, semantic clone detection brings more powerful instruments. Yet, limits on semantic clone detection exist. However, endpoint semantic similarity serves as an initial approximation to dealing with semantic clone detection, and the described embodiments additionally use high-level code constructs and meta-data with additional semantics.

Since microservice systems are built with component-based development frameworks, components can be recognized and interconnected across and within microservices, thereby enabling the formation of call graphs. A call graph is a representation of dependencies between microservices of a plurality of microservices of the microservice system that interact to perform an overall application function.

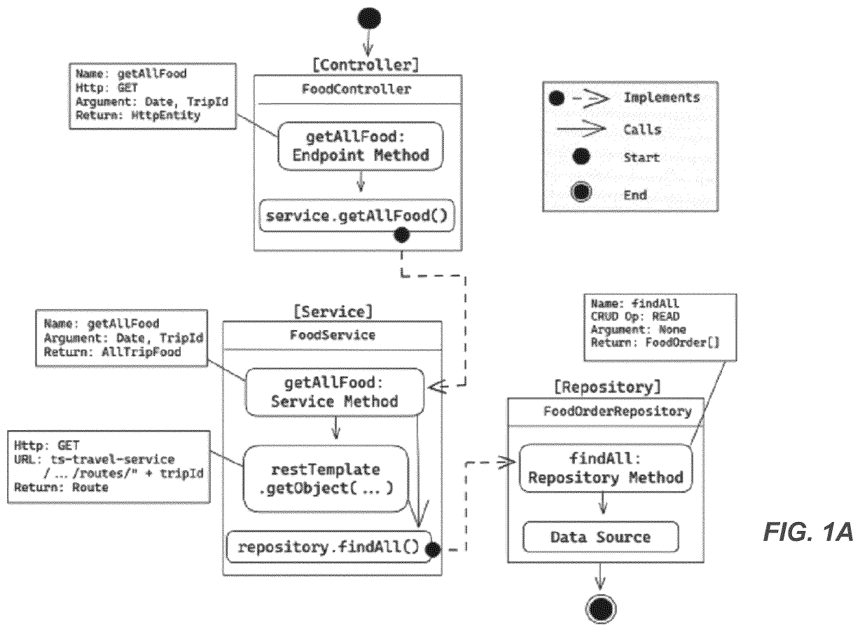

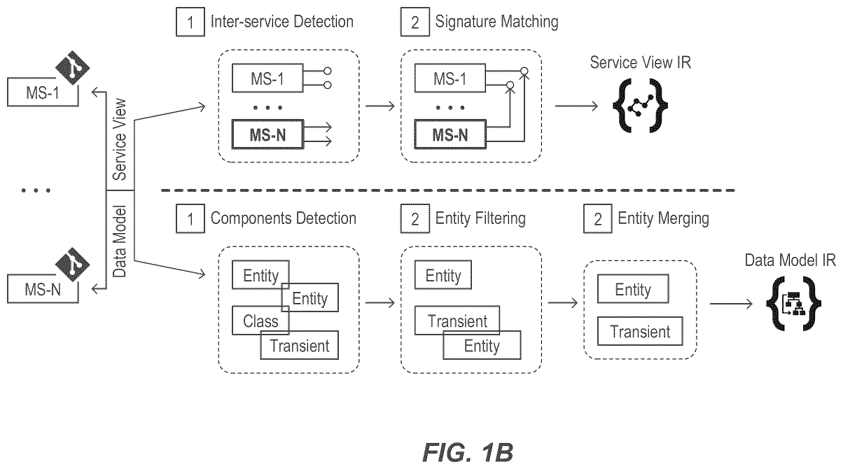

In some embodiments, the intermediate representation is a Component Call Graph (CCG) that is created by additional properties to each component, like its type and its properties, with connections implied by calls. An example of a CCG is illustrated in FIG. 1A. The type of each component is specified at the top between brackets. The properties that are extracted from each type are different, as can be seen in the cards attached to each component. The inclusion of these properties turns the call graph into a CCG. In some examples, individual CCGs can be created for every endpoint, thereby collectively representing a single microservice. As components are identified, one can also recognize external calls because they are executed via clearly defined interfaces or constructs. Furthermore, by gathering components and integrating their call sequences, types, and properties, the CCG intermediate representation of the microservice can be produced in a JavaScript Object Notation (JSON) format.

### B. Intermediate Representation Construction

This methodology leverages static code analysis techniques to construct the service view and data model of the domain view from the source code.

The methodology commences by iteratively examining the project folders within the system to identify standalone projects as microservices. This can be achieved through parsing specific deployment or configuration scripts found in the project folders, such as Docker Compose deployment files. Once identified, we harness the source code of each microservice to create the corresponding views.

### 1) Service View Construction:

The construction of the service view follows a two-phase process, as depicted in the upper portion of FIG. 1B. In the first phase, known as Inter-service Detection, static analysis is employed to extract endpoint declarations and endpoint requests initiated within the source code. In the second phase, referred to as Signature Matching, a regex-like approach is employed to match requests to their corresponding endpoints across different microservices. This matching process considers attributes of endpoints and requests, including endpoint paths, parameters, and HTTP method types, ultimately identifying connections between the source and destination microservices. The extracted information is represented as an intermediate representation (IR) of the service view.

### 2) Data Model View Construction:

The construction of the data model view comprises three phases, as illustrated in the lower portion of FIG. 1B. The first phase, termed Components Detection, involves identifying classes and their attributes within the source code. In the second phase, known as Entity Filtering, data entities are selected among the extracted class components. Then, both persistent and transient data entities are distinguished. Transient entities are identified based on attributes such as setters and getters, which are used in the responses of endpoint methods. Additionally, entity relationships are identified from attribute fields that reference other entities within the system. The third phase, termed Entity Merging, identifies entities that are candidates for merging from different microservices based on similar names and matching data types between their fields. The resulting information is represented as an intermediate representation (IR) of the data model view.

### 3) Intermediate Representation Formulization:

The two intermediate representations constructed from both views encompass vital attributes for depicting the system's interconnections and data dependencies. These attributes can be expressed using the following notations:

S={ms₁,ms₂, . . . ,msₙ};msᵢ= [symbol] Eᵢ,Cᵢ,Dₚᵢ,Dₜ_{ᵢ} [symbol] ;

Eᵢ={ [symbol] uⱼ,rⱼ,Pⱼ [symbol] , . . . };Cᵢ={msⱼ,uₖ,rₖ,Pₖ [symbol] , . . . };

Dₚᵢ={ [symbol] Fⱼ,Rᵢⱼ [symbol] , . . . };Dₜ_{ᵢ}={ [symbol] Fⱼ,Rᵢⱼ), . . . };

P={ [symbol] t,n [symbol] , . . . };Fᵢ={ [symbol] t,n [symbol] , . . . }
S—Microservice system, mₛᵢ—Single microservice.
Eᵢ—Endpoints defined in the microservice mₛᵢ
Cᵢ—Calls made from the microservice mₛᵢ to all other microservices.
D_{Pi}—Persistent data entities in the microservice mₛᵢ.
Dₜ_{ᵢ}—Transient data entities in the microservice mₛᵢ.
Rⱼ—Relationships that start from a data entity j to other entities.
Fⱼ—Fields in a data entity j.
P—Parameters in an endpoint or in a call.
u—URL path. r—Return type. t—Field date type. n—Field name.

The constructed views and their properties can be elucidated by categorizing the mentioned main five sets of extracted attributes. The process begins with a microservice system as input and subsequently analyzes the system to yield the following sets of attributes per microservice. A set of endpoints (E) introduced within each microservice, a set of request calls (C) initiated from each microservice towards endpoints in other microservices, and two sets of data entities: one for the persistent data entities (Dₚ) and the other for the transient data entities (Dₜ).

### C. Metrics Definition

The proposed seven metrics leverage the extracted centralized attributes from the system. They quantify the following attributes to describe a centric perspective of the microservice system and to assist in the reasoning about its evolution.

Metric 1. Number of Microservices (#μₛ).
Value: #μₛ=|S|.

The count of microservices in the system. It provides a quantitative measure of the system's scale or complexity in terms of microservices, and insights into the system's modularity evolution by showing expansions or contractions in high-level components between subsequent versions and releases.

Metric 2. Number of Microservices Connections (#Cμₛ).
Value: Σᵢ₌₁ⁿ|Cᵢ|; where n=|S|.

Number of endpoint calls between microservices in the system. It provides a measure of the communication intensity between microservices in the system, and reveals changes in the dependency view across system releases and identifies potential bottlenecks, such as excessive connections to a single service.

Metric 3. Number of Persistent Data Entities (#PDEₛ).
Value: Σᵢ₌₁ⁿ|Dₚᵢ|; where n=|S|.

The count of relational and non-relational persistent data entities in the system. It provides insight into the scale of persistent data entities within the system, and insights into the data perspective, such as the storage approaches per each microservices. In addition to the domain model, modularity changes throughout the system releases.

Metric 4. Number of Transient Data Entities (#TDEₛ).
Value: Σᵢ₌₁ⁿ|Dₜ_{ᵢ}|; where n=|S|.

Number of data entities used as data transfer objects across microservices (not persistent in storage). It provides an indication of the usage scale of data transfer objects, and illustrates the evolution of additional entities created for customizing responses and data transfer purposes but not involved in domain logic. It indicates whether each microservice consumes or delivers more data models to others.

Metric 5. Number of Relationships between Data Entities (#RDEₛ).
Value: |MR|/2, where MR=∪ᵢ₌₁ⁿ∪ⱼ₌₁^{m}{r, f(r)|r∈∪ₗRᵢⱼₗ}, n=|S|, and m=|Dₚᵢ|+|Dₜ_{ᵢ}|, and where f(r) is a function that reverses relationships to prevent duplicate counting of both the relationship and its reverse counterpart.

The count of relationships between data entities in each microservice's data model. It provides a measure of the complexity and interconnectedness of data entities within each microservice's data model, and demonstrates the evolution of data model complexity and the presence of cohesive models within each microservice over different releases.

Metric 6. Number of Merge Candidates Data Entities (#MDEₛ).
Value: (Σᵢ₌₁ⁿ|Dₚᵢ|+|Dₜ_{ᵢ}|)−|DE|, where DE={f_{d}(d)|d∈∪ᵢ₌₁ⁿ(Dₚᵢ+Dₜ_{ᵢ})} and n=|S|. Furthermore, f_{d}(d) is a function that receives an entity and returns the corresponding entity after the Entity Merging phase, and is defined as:

$${f}_{d} ( d ) = \{ \begin{matrix}d & if d not merged \\ {d}^{′} & if d was merged into {d}^{′}\end{matrix}$$

The count of entities duplicated in multiple bounded contexts. These entities may retain different fields based on the purpose of each bounded context. It provides insight into the level of duplication across bounded contexts, highlighting potential opportunities for consolidation or optimization, and shows bounded context changes over system evolution; it reveals data dependencies among microservices.

Metric 7. Number of Merge Candidates Relationships between Data Entities (#MRDEₛ).
Value: (Σᵢ₌₁ⁿΣⱼ₌₁^{m}|Rᵢⱼ|)−|RDE|, where RDE={fᵣ(r)|r∈∪ᵢ₌₁ⁿ∪ⱼ₌ᵢ^{m}Rᵢⱼ} and n=|S|. Furthermore, fᵣ(r) is a function that receive an relationship and returns the corresponding relationship after the Entity Merging phase, and is defined as:

$${f}_{r} ( r ) = \{ \begin{matrix}r & if r not merged \\ {r}^{′} & if r was merged into {r}^{′}\end{matrix}$$

The count of relationships that are candidate for merging based on the merge candidates between entities (#MDEₛ). It indicates potential opportunities for merging relationships between entities based on identified merge candidates, and provides a holistic data model view of the microservice system and showcases changes in data fragments across different system releases.

### D. Demonstrating Example

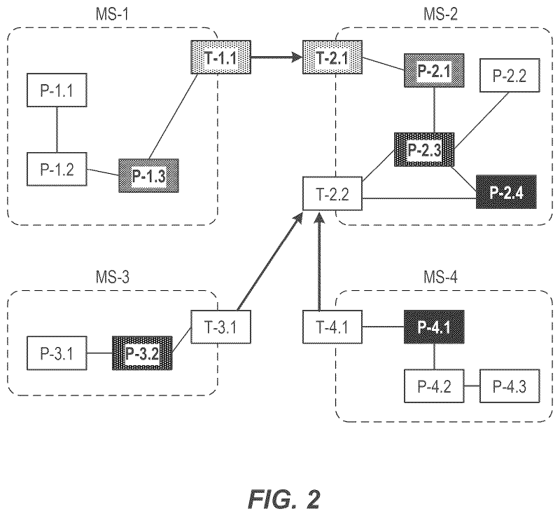

This section provides an example to illustrate the proposed metrics. The example consists of four microservices (MS-1 . . . . MS-4), where each microservice contains data entities, either persistent (P) or transient (T). These entities have relationships with each other, and the connections between microservices are depicted with arrows linking two transient entities that facilitate data transfer through these connections. Refer to FIG. 2 for a visual representation of this example.

Regarding the metrics related to the service view, and as shown in FIG. 2, the number of microservices in the system is four (#μₛ=4), and there are three request calls (#Cμₛ=3), which occur as follows: MS-1→MS-2, MS-3→MS-2, and MS-4→MS-2.

In the context of data view metrics, there are 12 persistent data entities (#PDEₛ=12). Specifically, MS-1 through MS-4 contain three, four, two, and three persistent data entities, respectively. On the other hand, there are five transient data entities (#TDEₛ=5). MS-2 has two transient data entities, while other microservices have one each. Furthermore, there are 14 relationships between these data entities (#RDEₛ=14): three relationships for each of MS-1 and MS-4, six relationships in MS-2, and two relationships in MS-3.

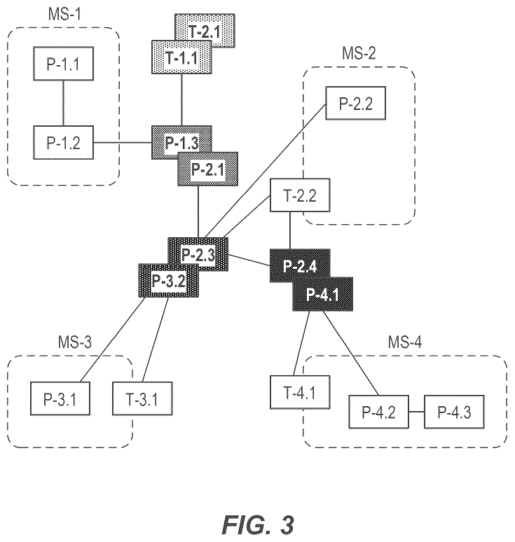

To illustrate the two metrics related to merge candidates, an example entity merging process is demonstrated to identify potential merge candidates between data entities, as depicted in FIG. 3. These resulting entities were generated by tracing the connections between transient data entities among microservices and the relationships between these transient and persistent data entities. In these two figures, entities with the same shading (e.g., from T-1.1 and T-2.1 being lightly shaded to P-2.4 and P-4.1 having white text on black backgrounds) represent similar entities that exist in multiple microservices' bounded contexts. By merging these similar entities into a single entity, the total number of data entity merge candidates is four (#MDEₛ=4). These candidates are (T-1.1 & T-2.1), (P-1.3 & P-2.1), (P-2.3 & T-3.2), and (P-2.4 & P-4.1). Additionally, there are one relationship merge candidate (#MRDEₛ=1), which is produced of merge of the relationship between (T-1.1 & P-1.3) and (T-2.1 & P-2.1). These two relationships were merged because the merging process occurred in both of the entities they connected (T-1.1 & T-2.1) and (P-1.3 & P-2.1).

### E. Intermediate Representation Visualization

Another component of the extracted information and the constructed intermediate representations lies in facilitating human-centered reasoning about the overall system. This approach to human-centered reasoning relies on visualization techniques to explore various facets of the system.

Moreover, the challenge of rendering space becomes crucial when visualizing microservices architecture and its associated views. In particular, visualizing the service view poses more intricate challenges due to its need to provide an overview of holistic, large, and scalable systems. To address this, we employ a three-dimensional visualization approach to present the service view intermediate representation. The three-dimensional display offers more rendering space, reducing the overlap among service connections. Additionally, our visualization allows for interactivity, enabling users to select nodes for highlighting nodes that are invoked by the selected node. Furthermore, we employ a color-coding scheme for microservices nodes, differentiating them based on their number of dependencies in comparison to a predefined value.

Conversely, for visualizing the data view, the class diagram is an apt choice. It displays the fields of each entity and their relationships. Our proposed visualization adapts the spatial representation by incorporating horizontal scrolling within a 2D space, allowing easy navigation through all system entities. To create a comprehensive data model, this methodology combines the entities identified as merge candidates (#MDEₛ) and the relationships indicated as merge candidate relationships (#MRDEₛ) into the model. This process results in the construction and visualization of a holistic context map for the entire system.

Alternatively, dependencies can be illustrated through remote call communication paths by the animation of yellow moving spheres. This works well for high-level dependencies, but most dependencies need a broader detail. To address this, hierarchical visual model navigation is provided. For example, it is possible to navigate from the current visual model that gives a system-level view to more detailed application-level views. This enables a selection of user-specified microservices, which would be rendered in a detailed view illustrating individual microservice endpoints and their interconnection and possibly moving further to illustrate CCG in the layered architecture of each microservice in the user selection or its methods. This hierarchical navigation could be complemented by additional coordinated views (e.g., a domain view). With such a hierarchical architectural model, the artifact dependencies that we have identified thus far could be illustrated.

These visual representations are instrumental in supporting the process of analyzing system evolution. They offer visual-centric perspectives of the system, aiding in the understanding of architectural changes as the system evolves.

### F. Intermediate Representation Deltas

Typically, the intermediate representation (IR) represents the system as a one-time instance. In some embodiments, the need to rebuild the intermediate representation (IR) from scratch is eliminated. For example, when a change is performed to a microservice, the current IR would need to be rebuilt to reflect the update. Rather than rebuilding the whole IR with each change, we intend to introduce deltas correlating to the specific change. The transition effect should be the same as if we build the IR before the change and after the change. However, the delta brings an important new aspect to change analysis. This is because the delta can be analyzed in the context of its impact on the system.

For example, the deltas that touch component properties or methods that have dependencies on other microservices can be highlighted in the visualization, as they could be the potential avenue for the ripple effect. Moreover, we intend to calculate these deltas from the changes rather than from the IR instance comparison. To address the deltas, we assume the existence of a current instance of system IR. Such IR could have been constructed by complete system assessment or by integration of preceding deltas (as described in the next text). Changes performed on a microservice codebase can be intercepted through the development pipelines and version control. For instance, a Git commit or pull request could be a source of a delta calculation on the IR. Such a delta impacts dedicated parts of the current system IR. This task intends to map the code/resource changes to the IR to mark out sources of change. Consequently, the dependencies related to the marked parts or directly connected paths (i.e., connected components in the CCG) will be assessed for potential impact. Calculated delta will encapsulate the change but will also update the system IR iteratively. To validate such a process, we can take any system benchmark version control, pick a historical and current version, and build complete system IRs. Next, we can iteratively extend the historical version with deltas by iterating through the version control history of changes. At the end of the process, we will compare the resulting system IR with the one constructed specifically for the current version.

### 3. Example Case Study

This section showcases the application of our proposed methodology to facilitate reasoning about system evolution. While the proposed metrics provide insights into central system perspectives, they do not inherently reveal the underlying reasons for variations between different system versions. Consequently, these metric values serve as indicators, prompting architects and practitioners to explore the drivers of system changes. Therefore, centralized system view visualizations play a pivotal role as an instrument for enabling practitioners to delve into the causes behind the metric fluctuations.

To demonstrate the efficacy of the disclosed embodiments, the proposed metrics and visualizations have been implemented in a prototype and applied to an open-source testbench to assess and discuss its architectural evolution characteristics. This case study serves the following objectives:
Evaluating feasibility of applying the proposed metrics to a real-life system.
Emphasizing the significance of the proposed metric measurements in guiding practitioners to investigate specific aspects of the system.
Demonstrating the role of visualizations in presenting holistic views of the entire system.

### A. TestBench

The Train-Ticket microservices testbench was utilized to demonstrate the case study. This is commonly used in the research community as it is a good representative of real-life systems. It is implemented using Java-based Spring Boot framework, and contains a couple of Python microservices. Its repository contains seven releases (at the time of filing this application). To demonstrate the evolution impact on the system architecture, this case study selects the following three different releases (versions): v0.0.1, v0.2.0, and v1.0.0. Those versions show a progressive evolution of the system starting from the first release (v0.0.1) until the current latest release (v1.0.0).

Spring Boot: https://spring.io/projects/spring-boot
v0.0.1: https://github.com/FudanSELab/train-ticket/tree/0.0.1
v0.2.0: https://github.com/FudanSELab/train-ticket/tree/v0.2.0
v1.0.0: https://github.com/FudanSELab/train-ticket/tree/v1.0.0

### B. Prototype Implementation

We implemented the proposed approach in a prototype. It is built for analyzing Java-based microservices projects that use the Spring Boot framework. It utilized static source code analysis techniques to extract the data necessary for calculating the metrics and also for constructing the intermediate representations of the service view and data view. The extracted data is published at an online dataset.

The dataset is available at https://zenodo.org/records/10052375

It accepts its input as a GitHub repository containing microservices-based projects. It scans each microservice for finding the Spring Boot REST client (i.e., RestTemplate client) to detect HTTP calls between the services. It matches the detected calls with the endpoints. Moreover, it extracts the bounded context data model of the individual microservices. It scans all local classes in the project using a source code analyzer. To filter this list down to classes serving as persistent and transient data entities, it checks for persistence annotations (i.e., JPA standard entity annotations such as @Entity and @Document), and also, for annotations from Lombok (i.e., @Data), a tool for automatically creating entity objects. To check merge candidates, it uses the WS4J project, which uses the WordNet project to detect name and fields similarity. This prototype outputs a JavaScript Object Notation (JSON) representation for the service and data views intermediate representations.

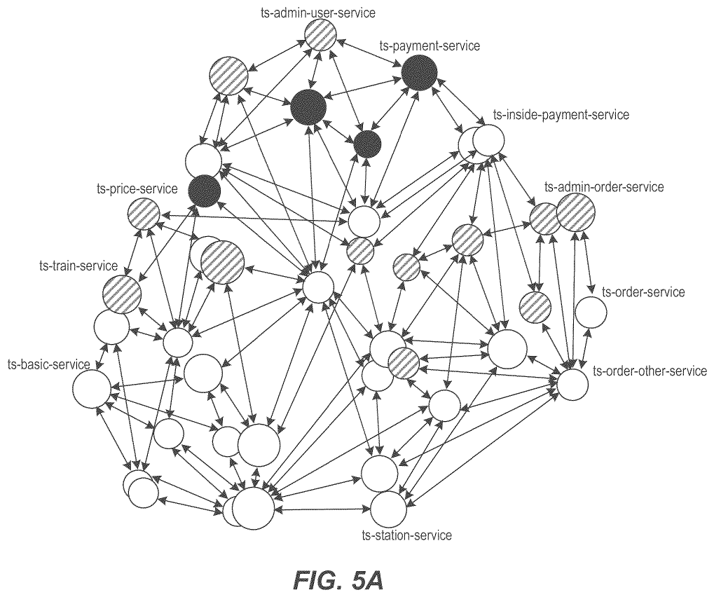

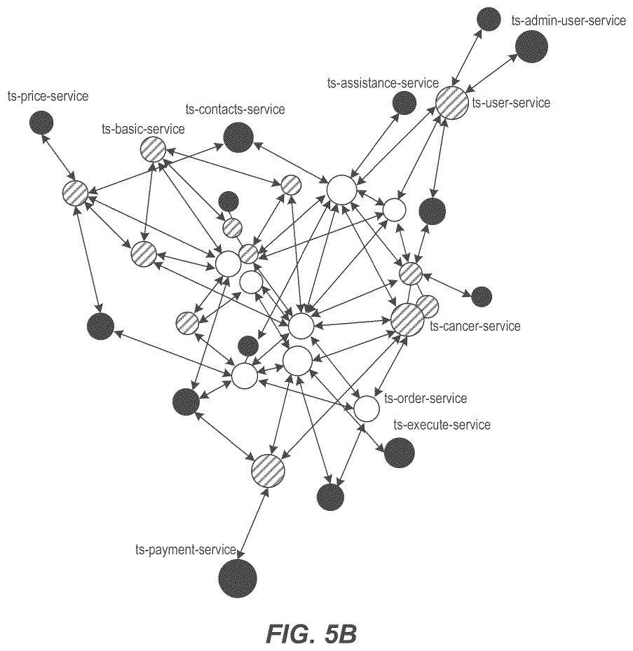

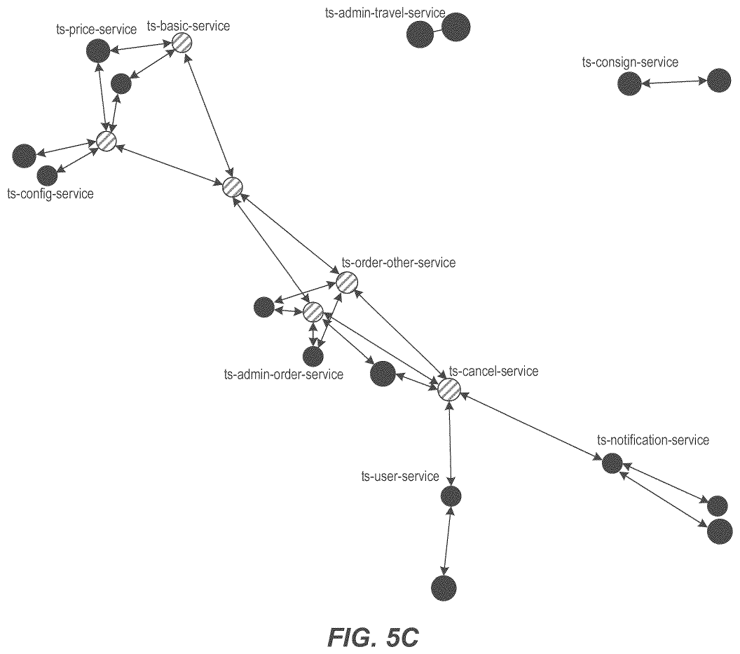

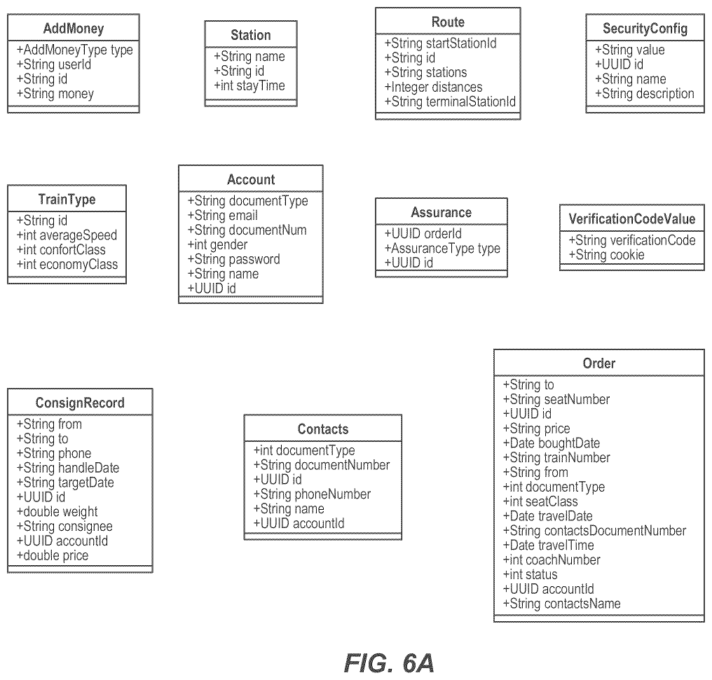

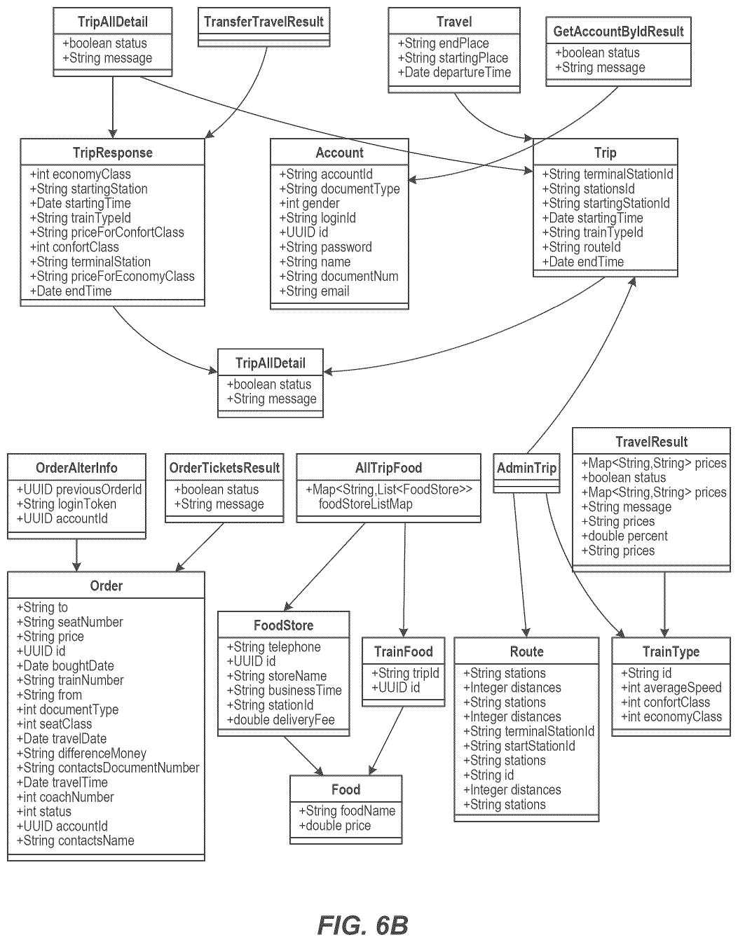

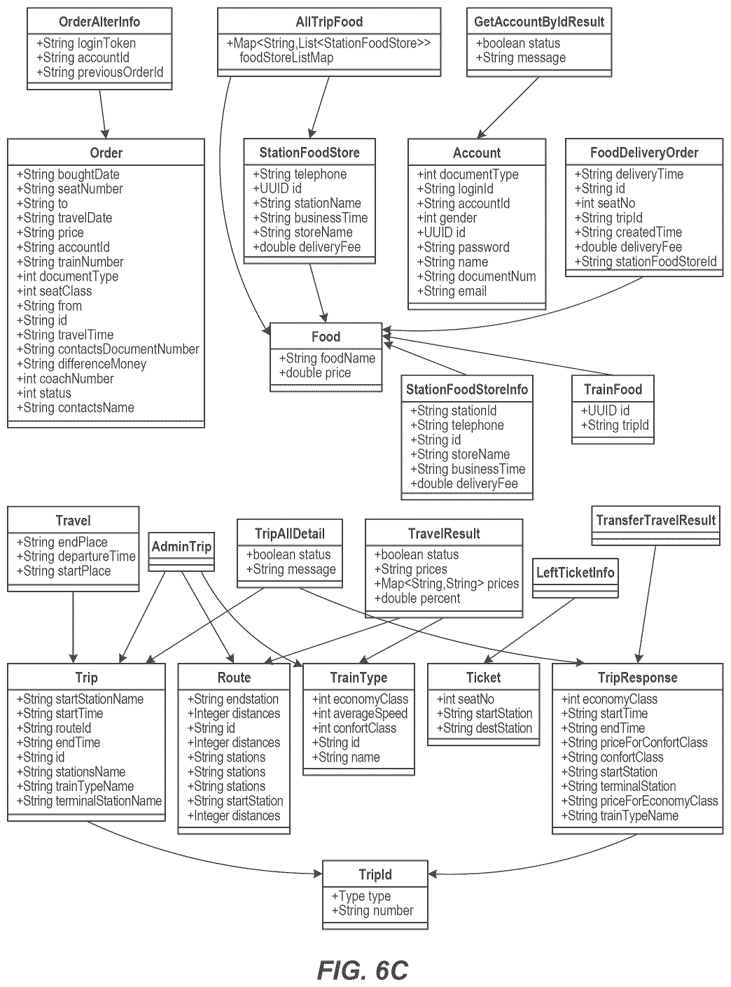

Moreover, the 3D visualizer is implemented to present the constructed intermediate representations. The 3D visualizer uses the ThreeJS library to visualize the service view in a graph representation, as shown in FIGS. 5A-5C. Alternatively, it uses the Mermaid library for rendering the data view in a class diagram representation, as shown in FIGS. 6A-6C. The nodes in FIGS. 5A-5C (although not explicitly labeled) are part of the Train-Ticket microservices testbench that includes the following microservices:

TABLE 0
List of Train-Ticket v1.0.0 microservices and corresponding IDs

| ID | Name |
|---|---|
| 1 | ts-common |
| 2 | ts-travel-service |
| 3 | ts-travel2-service |
| 4 | ts-assurance-service |
| 5 | ts-auth-service |
| 6 | ts-user-service |
| 7 | ts-config-service |
| 8 | ts-consign-service |
| 9 | ts-contacts-service |
| 10 | ts-food-service |
| 11 | ts-payment-service |
| 12 | ts-inside-payment-service |
| 13 | ts-notification-service |
| 14 | ts-order-other-service |
| 15 | ts-order-service |
| 16 | ts-price-service |
| 17 | ts-route-service |
| 18 | ts-station-service |
| 19 | ts-food-delivery-service |
| 20 | ts-station-food-service |
| 21 | ts-train-food-service |
| 22 | ts-train-service |
| 23 | ts-admin-user-service |
| 24 | ts-rebook-service |
| 25 | ts-basic-service |
| 26 | ts-cancel-service |
| 27 | ts-admin-basic-info-service |
| 28 | ts-admin-order-service |
| 29 | ts-admin-route-service |
| 30 | ts-admin-travel-service |
| 31 | ts-consign-price-service |
| 32 | ts-delivery-service |
| 33 | ts-execute-service |
| 34 | ts-preserve-other-service |
| 35 | ts-preserve-service |
| 36 | ts-route-plan-service |
| 37 | ts-seat-service |
| 38 | ts-security-service |
| 39 | ts-travel-plan-service |
| 40 | ts-verification-code-service |
| 41 | ts-wait-order-service |
| 42 | ts-gateway-service |

### C. Metrics Quantification (Q_{1.1})

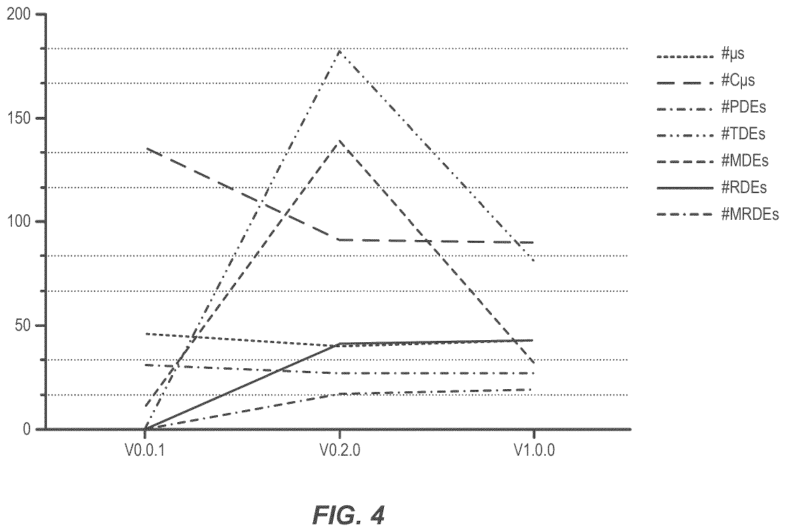

The prototype was applied to the three distinct releases of the Train-Ticket Testbench. The seven proposed metrics are listed in Table 1 and plotted in FIG. 4.

TABLE 1
TrainTicket Metrics Values

| Metric | v0.0.1 | v0.2.0 | v1.0.0 |
|---|---|---|---|
| 1. #μₛ | 46 | 40 | 43 |
| 2. #Cμₛ | 135 | 91 | 90 |
| 3. #PDEₛ | 31 | 27 | 27 |
| 4. #TDEₛ | 0 | 182 | 81 |
| 5. #RDEₛ | 0 | 41 | 43 |
| 6. #MDEₛ | 11 | 139 | 32 |
| 7. #MRDEₛ | 0 | 17 | 19 |

In the table above, the first two metrics are part of the Service View and remaining metrics 3-7 are part of the Data View. With these metrics at our disposal, the system's evolution can be interpreted across the three versions, as outlined below:

Metric 1. Number of Microservices (#μₛ).

It decreased from 46 in v0.0.1 to 40 in v0.2.0 and then slightly increased to 43 in v1.0.0. This indicates a reduction in the system's high-level components or a consolidation of functionality.

Metric 2. Number of Microservices Connections (#Cμₛ).

It decreased from 135 in v0.0.1 to 91 in v0.2.0 and remained relatively stable at 90 in v1.0.0. This suggests a decrease in the interdependence between microservices or a more optimized communication pattern.

Metric 3. Number of Persistent Data Entities (#PDEₛ).

It remained relatively constant across all versions, starting at 31 in v0.0.1 and remaining consistent at 27 in both other versions. This indicates stability in the storage approach and domain model for the microservices.

Metric 4. Number of Transient Data Entities (#TDEₛ).

It increased significantly from 0 in v0.0.1 to 182 in v0.2.0 and dramatically decreased to 81 in v1.0.0. This suggests the introduction of additional entities for customizing responses and data transfer purposes, which decreased in the latest version to optimize the usage of entities across microservices.

Metric 5. Number of Relationships between Data Entities (#RDEₛ).

It started at 0 in v0.0.1, increased to 41 in v0.2.0, and further to 43 in v1.0.0. This suggests the evolution of the data model complexity and the establishment of relationships between entities.

Metric 6. Number of Merge Candidates Data Entities (#MDEₛ).

It increased from 11 in v0.0.1 to 139 in v0.2.0 and decreased to 32 in v1.0.0. This indicates a growing complexity in the bounded contexts and the need for merging similar entities.

Metric 7. Number of Merge Candidates Relationships between Data Entities (#MRDEₛ).

It started at 0 in v0.0.1, increased to 17 in v0.2.0, and further to 19 in v1.0.0.

This indicates the emergence of candidate relationships for merging based on similar entities.

The analysis of these metrics offers valuable insights into the system's evolution, shedding light on shifts in microservice count, microservice connections, diverse data entities, and their relationships across the entire system. A more profound understanding can be achieved when considering the relationships between these metrics and exploring the cause behind these metrics indicators. Further exploration of the reasoning about the system will be addressed in the subsequent subsections.

### D. Intermediate Representation Visualization (Q_{1.2})

The flexibility of the presented intermediate representation allows it to adapt and be visualized through various visualization tools. These visualizations can significantly reduce the effort required to investigate and understand the source code. The intermediate representation provides holistic viewpoints (service and data) through tailored approaches.

In some embodiments, the prototype provides visual intermediate representations of the service view and data model view of the system. The service view, presented using 3D visualization in FIGS. 5A-5C, highlights changes in the system's microservices (#μₛ) and interconnections (#Cμₛ). It exhibits reduced coupling in the latest version compared to the initial one.

In terms of the data view, the number of entities increases in the holistic context map as we move from one version to the next. After the prototype merges entity candidates and relationships, the constructed context map comprises 20, 70, and 76 entities in versions v0.0.1, v0.2.0, and v1.0.0, as detailed in Table 2. This reflects the merging of both persistent and transient data models while eliminating candidate entities of both types. The prototype visualizes the evolution of the context map, as shown in FIGS. 6A-6C, illustrating changes in the context map and how entities connected with each other as the system evolves.

TABLE 2
Merging Data Entities

| Data Entity | v0.0.1 | v0.2.0 | v1.0.0 |
|---|---|---|---|
| #PDEₛ | 31 | 27 | 27 |
| #TDEₛ | 0 | 182 | 81 |
| #MDEₛ | 11 | 139 | 32 |
| Context Map (Merged) | 20 | 70 | 76 |

### E. Architectural Evolution Reasoning (Q₁)

System architects and practitioners need to consider not only the raw metrics but also the underlying architectural changes and design decisions that influence these metrics. The interconnected nature of microservices means that changes in one area can have ripple effects throughout the system. Further analysis and exploration of the relationships between these metrics can provide a more comprehensive understanding of the system's evolution and its implications for quality and performance.

### Reasoning-Based Questions Analysis.

Analyzing the metrics values prompts questions regarding the system's properties during its evolution. While some team members familiar with the system may know the answers, practitioners often need to delve into the individual source code of each microservice to investigate. Therefore, centralized visualization of the system view is introduced to significantly reduce the effort required to explore various aspects of the system, especially when it requires an entire merged perspective. Several case study reasoning questions (CQ) have arisen from this case study metrics values, the following list highlights some of them:
CQ1. What factors contributed to the high number of connections in the v0.0.1 service view compared to the other two versions?
CQ2. What explains the disparity between the number of relationships and entities?
CQ3. Why are there no relationships and transient entities in v0.0.1?
CQ4. What is the reason for the substantial number of merged entity candidates (#MDEₛ), particularly in v0.2.0?

In response to CQ1, the reduced number of connections in v0.0.1 can be attributed to the presence of multiple composite microservices that require communication with other services to fulfill their functionalities. This can be exemplified by considering two services, ts-preserve-service and ts-station-service. The former, ts-preserve-service, lacks persistence storage but relies on 12 other microservices to accomplish its functions. Conversely, the latter, ts-station-service, has no dependent services but boasts 21 dependencies.

Furthermore, addressing CQ2, the logical relationships between entities rather than direct connections can explain the metrics indication. For instance, the Listing 1 demonstrates that the FoodStore entity within ts-food-service utilizes the stationld field to store the ID value of a Station entity, even though no established relationship formally links the two entities. Additionally, the structure of certain microservices, such as ts-station-service, featuring persistent storage, while others, like ts-preserve-service, lack this feature, can add more justification to this question.

Listing 1: Logical relationship in ts-food-service (FoodStore entity)

| | |
|---|---|
| 1 | @Data |
| 2 | public class FoodStore { |
| 3 | private UUID id; |
| 4 | //logical relationship |
| 5 | private String stationId; |
| 6 | } |

Answering CQ3 involves two key considerations. Firstly, the absence of transient data entities in v0.0.1, unlike the other two versions, is attributed to the fact that v0.0.1 does not employ Lombok annotations to annotate their transient data classes. Consequently, the prototype could not guarantee other hypotheses for identifying transient entity types. Furthermore, upon investigation, it was revealed that v0.0.1 uses some of the persistent data entities for the purpose of transferring data between microservices. While this may appear as a limitation in the prototype's implementation, after investigation, it highlights an evolutionary perspective on the diverse techniques and strategies employed by v0.0.1 for handling transient data entities, distinct from the approaches taken in the other two versions. The second aspect of this question pertains to the different types of persistent data entities. In v0.0.1, in addition to the absence of transient data entities, no relationships were extracted. This is because v0.0.1 utilizes MongoDB as its persistence storage, which is a non-relational database. As summarized in Table 3, it shows that the system transitioned from non-relational to relational databases in the latest version.

TABLE 3
Data Entity Types

| Data Entity | v0.0.1 | v0.2.0 | v1.0.0 |
|---|---|---|---|
| NoSQL | 29 | 27 | 0 |
| SQL | 2 | 0 | 27 |
| #PDEₛ | 31 | 27 | 27 |

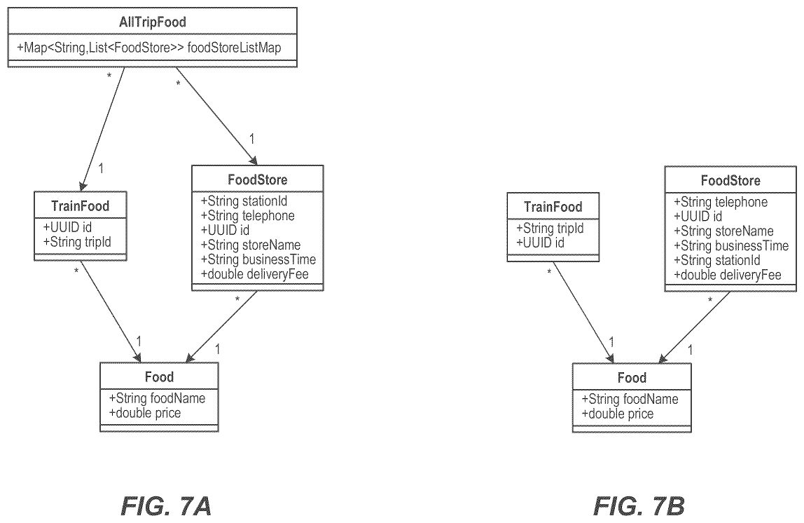

Addressing CQ4, this study provides insights into the process of merging entities across multiple bounded contexts. As highlighted in Table 2, v0.2.0 contains a total of 209 entities (#PDEₛ+ #TDEₛ) within its bounded context. However, this number of entities is significantly reduced to 70 entities within the context map after merging 139 candidate entities. Upon closer examination of the system's source code, it becomes apparent that 39 entities are duplicated across multiple microservices in v0.2.0. This duplication issue is particularly evident in v1.0.0, where 39 entities are consolidated into a single shared microservice named ts-common to address this concern. This is demonstrated in FIGS. 7A and 7B, which illustrate the following three related entities, Food, TrainFood, and FoodStore, being duplicated within two bounded contexts of ts-food-service and ts-food-map-service, respectively. Therein, entities are represented in boxes with titles and attributes, connected by directed arrows indicating multiplicity (using “1” for one and “*” (asterisk/star) for many).

### Resolution-Based Reasoning

In addition to the case study questions, it is essential to delve into the issues present in v0.0.1 and the resolutions in v1.0.0. The initial system design exhibited some problematic tendencies, there are many small nano-services, which is a recognized anti-pattern for microservices. It can also be described as a microservice greedy anti-pattern, where new microservices were created for each feature, even when they were unnecessary, as evident in later versions when they were merged and consolidated. Furthermore, in v0.0.1, only half of these microservices defined data entities, while the other half appeared to serve as transfer services in the business layer. This approach can be characterized as a wrong cuts anti-pattern, dividing the system into layers based on functionality rather than domain considerations, which was previously confirmed in a study that also analyzed this testbench.

Considering the service view in FIGS. 5A-5C, v0.0.1 displayed numerous complex coupling knots, indicating a design prioritizing over-engineered decomposition rather than adhering to Conway's law. In contrast, v1.0.0 showed better alignment with Conway's law (which states that in order for a product to function, the authors and designers of its component parts must communicate with each other in order to ensure compatibility between the components, i.e., complex products end up “shaped like” the organizational structure they are designed in or designed for). This correlation is also reflected in the number of connections in Table 1.

An important observation lies within Table 2. While most dynamic analysis tools consider service calls as the foundation for service connections, the merge entity candidates can indicate another dimension of connectivity when many entities within the system represent the same concept. This observation presents an efficient mechanism for connecting microservices beyond service calls. v0.2.0 contains 209 scattered entities across the system that are reduced to 70 within the context map. Such a process is non-trivial for human-based analysis and would require manual merging with each system change, and would be impractical to perform manually.

### Human-Centric Reasoning

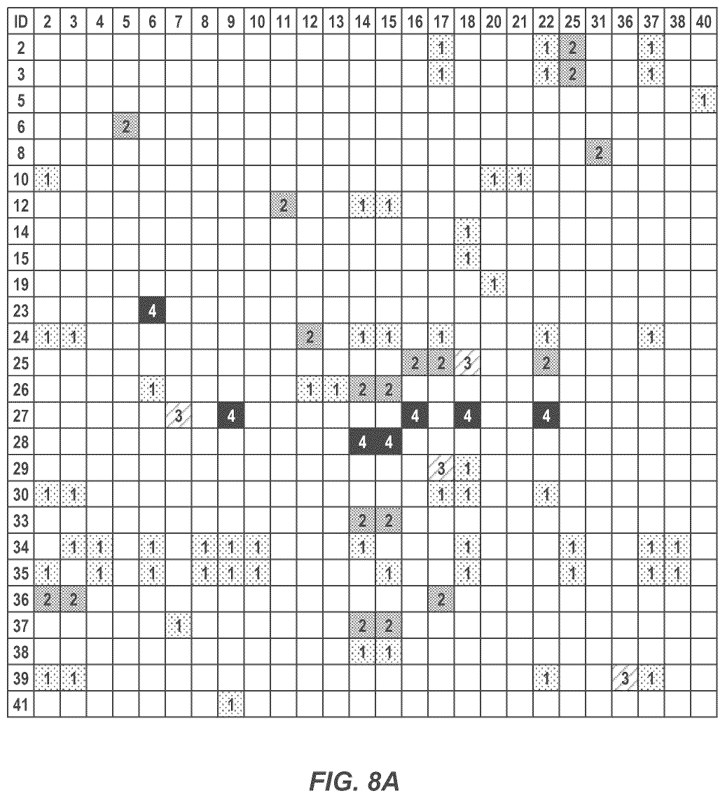

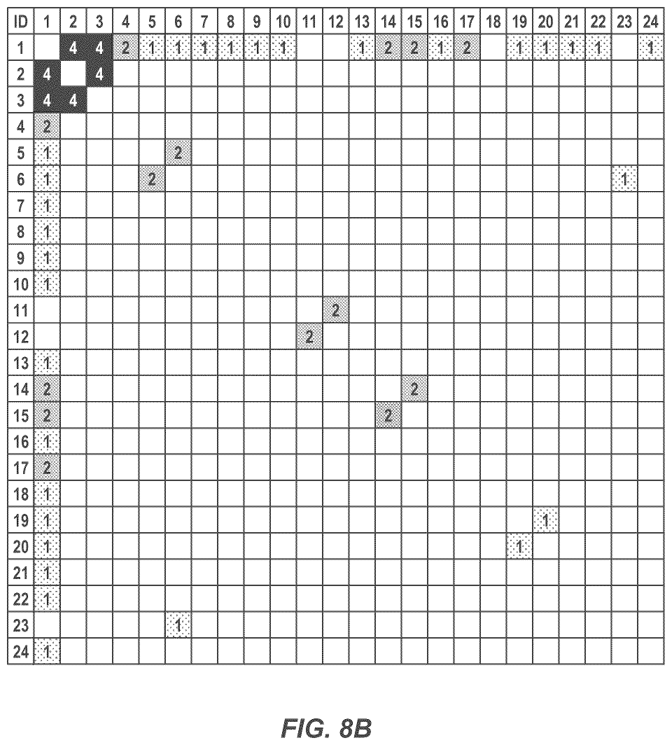

FIGS. 8A and 8B illustrate example heat matrices that depict the number of dependency connections between pairs of microservices in TrainTicket v1.0.0 (as shown in FIG. 8A) and to display data viewpoints through the relationships between data entities and identify merge candidates among microservices (as shown in FIG. 8B). The matrices display the number of corresponding dependencies within the cells, using different shading to represent them-darker shading indicates more dependencies between each pair. The IDs in the heat matrices correspond to the microservices listed in Table 0.

### 4. Discussion

This study adopts a centric perspective to examine the architectural evolution of microservices. It specifically focuses on the extraction and representation of the holistic system from the service and data model views. To achieve this, a set of seven metrics is introduced and applied to quantify various properties within these two viewpoints. These metrics cover aspects like microservice count, inter-service connections, data entity types, and relationships. Consequently, they provide valuable insights into explaining how the system evolves (addressing Q_{1.1}).

Furthermore, the study leverages intermediate representations derived from the system's source code for these two viewpoints. These representations are then visually presented using tailored techniques. The primary aim is to facilitate the process for practitioners to explore and understand the system's central properties (addressing Q_{1.2}). By comparing the metric values and the visual representations across different system versions, we gain a roadmap and guidance to understand the system's evolution, particularly in terms of changes in its central properties (addressing Q₁).

### Metrics as Indicators.

The significance of these metrics lies in their ability to serve as indicators of system evolution, offering insights across various dimensions. While the metrics provide indicators about the relative changes when compared across different versions, they also play a vital role in exploring relationships between different metrics within the same version. This enables the reasoning about specific system features and the detection of patterns within the system, as demonstrated in the case study.

### Metrics Granularity.

The proposed metrics present abstract indicators of the holistic perspective of service and data viewpoints, and their granularity can be tailored to different levels within the system. This granularity can be examined at the individual microservice level, allowing the metrics to indicate correlations between microservices within the same version and a single microservice across multiple versions. Furthermore, the granularity can be extended from a technological standpoint, considering the polyglot architecture of microservice-based systems, which utilize various programming languages and technologies. Thus, these metrics can offer insight into the evolution of service and data views in an additional dimension of heterogeneity.

At the same time, granularity can be fine-tuned for each individual metric. For example, the metric of the number of persistent data entities (#PDEₛ) can be further divided into relational and non-relational data entities, as demonstrated in the case study. However, this study has chosen the current level of granularity to provide a direct indicator of persistence, with the option to explore different types if the metric values indicate the need for further investigation. A similar granularity approach can be applied to the metric of the number of microservice connections (#Cμ), differentiating between synchronous and asynchronous calls, depending on the specific analysis requirements.

### Intermediate Representation Extension.

The proposed intermediate representations of the system views contain essential information used for metric extraction and viewpoint visualization. While the proposed methodology primarily employs static source code analysis, dynamic analysis is another valuable technique. Dynamic analysis involves runtime data, which can construct the service view. Previous studies have utilized dynamic analysis to extract the service view, based on remote procedure calls gathered from logs and traces, and to detect anomalies in microservice-based systems. Therefore, extending the intermediate representation to include dynamic data analysis alongside the static representation, particularly for the service view, can offer additional metrics to illustrate the system's runtime behavior evolution.

Furthermore, the described methodology can be expanded to include event-based connections. The current representation predominantly focuses on endpoint connections, whereas event-based connections may require additional considerations and interpretations, given the potential one-to-many relationships between a single producer and multiple consumers in an indirect communication manner. Additionally, the intermediate representation can be broadened to encompass additional system viewpoints, including the technology view and operational view.

### Visualization Effectiveness.

While the visualization introduced in this study serves as an instrument for presenting a central view of the system, its selection was informed by a series of user studies involving practitioners. These studies validated the effectiveness of the visualization approaches in enhancing system understandability.

Furthermore, the flexibility of the visualization offers the potential to incorporate additional information that can aid practitioners in comprehending more aspects of the system. It can include annotations for different data entity types and various call types. Additionally, it can highlight additional anti-patterns, as demonstrated by its color-coding approach to indicate the degree of coupling between microservices.

### Alternatives to Source Code Analysis

In some embodiments, and apart from the source code perspective, other resources in the codebase that might include other dependency concerns and include the configuration files, build files, etc. are considered. For instance, shared resources, configuration settings, and environmental parameters can be tracked. This includes a shared repository, where multiple microservices use common data storage and retrieval, which, while promoting data sharing, can lead to dependency between services. This perspective relates to shared libraries, which become the source of dependency across services when changes are made (i.e., security patches). Additionally, it relates to the centralized cloud-native components like Configuration Servers, Service Discovery, and API Gateways to enable seamless communication between microservices. However, this perspective also spans technology dependencies. Such dependencies can be developed towards frameworks or technologies, and as they change, many code artifacts can be impacted. This could relate to third-party products that change constructs, APIs, or syntax and impact various microservices. For instance, if we utilize a specific database connector rather than indirection and object relational mapping. Database connector change can impact the system. Dependencies on such matters could be directed toward specific technologies, from where generalizations could be analyzed.

### 5. Threats to Validity

In this section, we evaluate the potential threats to the validity based on the classification proposed in a previous study. For the Construct Validity, our methodology focuses on constructing service and data views. We utilize the Train-Ticket testbench, a widely accepted benchmark in the microservices community.

In terms of Internal Validity, manual analysis for validating the extracted data performed by the authors. To ensure unbiased analysis, the data validation and the prototype is executed by different authors. However, potential threats may arise from the testbench project's structure and conversion. For instance, some entities in v0.0.1 lack Lombok annotations, causing our methodology to miss them. This inconsistency can lead to inaccurate indicators of extracted data entities, necessitating further investigation. Furthermore, the prototype does not detect event-based communications for interaction, although it does occur a few times within the assessed testbench, where the main connections primarily rely on REST endpoint calls. However, this does not affect the metrics' evolution, as these communication patterns remain consistent across different versions.

Regarding External Validity, our methodology offers general processes for constructing service and data views, applicable regardless of the programming language or framework. However, the implemented prototype is specific to the Java language and the Spring Boot framework. Adapting it to different languages would require non-trivial changes to the underlying logic. Additionally, the choice of Train-Ticket as the case study testbench is a limitation since being a testbench rather than a real-world microservices system somewhat limits its authenticity in reflecting actual system evolution. Nonetheless, we selected a broad range of system versions to emphasize the evolutionary changes.

Conclusion Validity is drawn from the case study's results, which illustrate the analysis capabilities of our method concerning specific architectural views. The case study encompasses multiple reasoning approaches, as discussed in the case study section, thereby validating and justifying our methodology for reasoning about architectural evolution. The results clearly demonstrate modifications in the system architecture and the resolution of multiple issues as the system evolves.

As discussed above, the disclosed embodiments address current gaps in microservice systems by introducing a system-centered perspective derived through static source code analysis. It emphasizes two viewpoints on service interaction and data overlaps, elaborating on the analysis process and results for comprehensive visualization. Seven metrics were defined that serve as indicators for understanding system changes holistically, facilitating efficient system evolution reasoning and version comparisons.

A case study demonstrated the methodology, highlighting the significance of metrics and visualization in enhancing the understanding of system evolution properties. It showed that changes in system architecture could be approached from different granularity levels, utilizing holistic insights for various reasoning perspectives, including reasoning-based questions and resolutions.

Additional embodiments involve applying these metrics at different granularity levels, extending the intermediate representation to include event-driven calls, dynamic data, and other architecture viewpoints.

### 6. Example Implementations and Embodiments

Implementations of the disclosed technology would deliver maintainability safeguards for developers of microservice systems, aid with the ever-growing complexity of these systems aiming to mitigate ripple effects, and transform the decentralized evolution process. The advancements will better account for the impact of a change made to individual microservices with the span to the ecosystem, which is currently difficult to estimate and might cause expensive ripple effects or lead to architectural degradation of the system. New safety guards will mitigate the chances of ripple effects in decentralized development environments and advance the development process to be more controlled. As a result, cloud-native systems will become more sustainable, reducing maintenance costs and providing better assurance mechanisms.

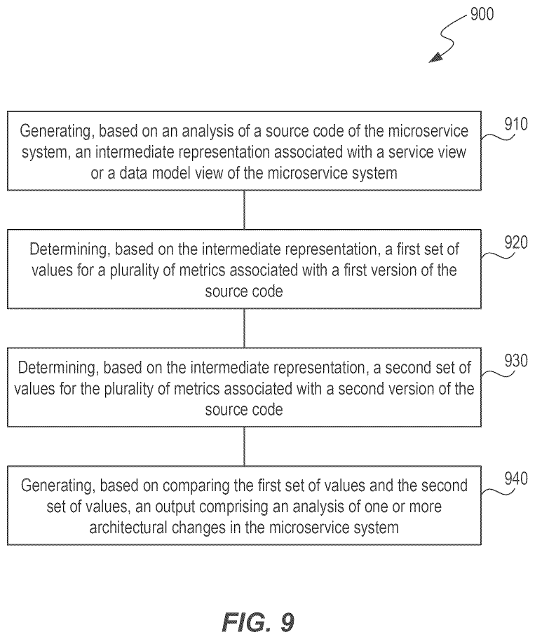

FIG. 9 illustrates a flowchart of an example method of tracking an evolution of a microservice system that includes a plurality of microservices, in accordance with the described embodiments. As shown therein, method 900 includes, at operation 910, generating, based on an analysis of a source code of the microservice system, an intermediate representation associated with a service view or a data model view of the microservice system.

Method 900 includes, at operation 920, determining, based on the intermediate representation, a first set of values for a plurality of metrics associated with a first version of the source code.

Method 900 includes, at operation 930, determining, based on the intermediate representation, a second set of values for the plurality of metrics associated with a second version of the source code.

Method 900 includes, at operation 940, generating, based on comparing the first set of values and the second set of values, an output comprising an analysis of one or more architectural changes in the microservice system.

In some embodiments, the intermediate representation comprises a component call graph (CCG) for at least one microservice of the plurality of microservices, and the CCG is rooted with an endpoint of the at least one microservice.

In some embodiments, the plurality of metrics comprise at least one of a number of the plurality of microservices in the microservice system; a number of microservices connections in the microservice system; a number of persistent data entities in the microservice system; a number of transient data entities in the microservice system; a number of data relationships between data entities in the microservice system; a number of candidate data entities in the microservice system for merging; or a number of candidate data relationships between data entities in the microservice system for merging.

In some embodiments, the method 900 further includes generating, based on one or more of the plurality of metrics, a visualization of the microservice system.

In some embodiments, the visualization represents each microservice of the plurality of microservices as a node, and the visualization comprises an interactive three-dimensional visualization that enables selecting a particular node and highlighting nodes that are invoked by the particular node.

In some embodiments, the visualization comprises a color-coding scheme that differentiates microservices based on their number of dependencies compared to a predefined value.

In some embodiments, the visualization comprises a hierarchical visual model that enables navigation from a current visual model that gives a system-level view to one or more detailed application-level views.

In some embodiments, the second version of the source code comprises at least one new module or remote call that is absent from the first version of the source code, and the output comprising the analysis is generated prior to compiling the second version of the source code.

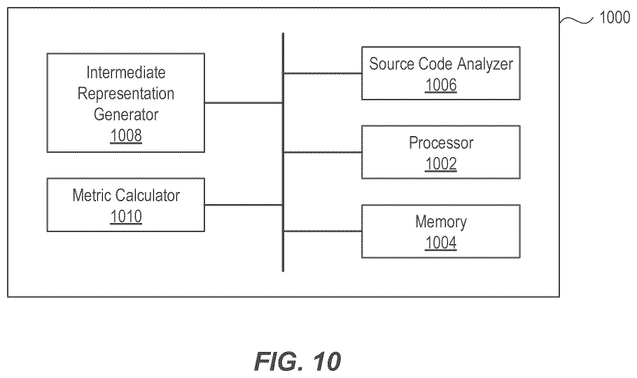

FIG. 10 shows an example of a hardware platform 1000 that can be used to implement some of the techniques described in this patent document. For example, the hardware platform 1000 may implement the various modules and algorithms described herein. The hardware platform 1000 can include a processor 1002 that can execute code to implement a method. The hardware platform 1000 can include a memory 1004 that is used to store processor-executable code and/or store data. The hardware platform 1000 may further include a source code analyzer 1006, a intermediate representation generator 1008, and a metric calculator 1010, each of which can communicate with the processor 1002. In some embodiments, the processor 1002 may include one or more processors implementing at least a portion (or the entirety) of the source code analyzer 1006, the intermediate representation generator 1008, and/or the metric calculator 1008. The processor 1002 may be configured to implement inter-service detection, signature matching, component detection, entity filtering, entity merging, and/or other microservice evolution assessment algorithms. In some embodiments, the memory 1004 may include multiple memories, some of which are exclusively used by the processor 1002 when implementing the source code analyzer, the intermediate representation generator, and/or the metric calculator algorithms.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A system for tracking an evolution of microservice systems, comprising:
a microservice system comprising a plurality of microservices that interact to perform an overall application function, each microservice of the plurality of microservices being associated with at least one endpoint and configured to perform a partial function of the overall application function, wherein the at least one endpoint of a corresponding microservice enables a user or another microservice to interact with the corresponding microservice; and
one or more processors configured to:
generate, based on an analysis of a source code of the microservice system, an intermediate representation associated with a service view or a data model view of the microservice system,
determine, based on the intermediate representation, a first set of values for a plurality of metrics associated with a first version of the source code,
determine, based on the intermediate representation, a second set of values for the plurality of metrics associated with a second version of the source code, and
generate, based on comparing the first set of values and the second set of values, an output comprising an analysis of one or more architectural changes in the microservice system.

2. The system of claim 1, wherein the intermediate representation comprises a component call graph (CCG) for at least one microservice of the plurality of microservices, and wherein the CCG is rooted with an endpoint of the at least one microservice.

3. The system of claim 1, wherein the plurality of metrics comprise at least one of:
a number of the plurality of microservices in the microservice system;
a number of microservices connections in the microservice system;
a number of persistent data entities in the microservice system;
a number of transient data entities in the microservice system;
a number of data relationships between data entities in the microservice system;
a number of candidate data entities in the microservice system for merging; or
a number of candidate data relationships between data entities in the microservice system for merging.

4. The system of claim 1, further comprising:
a visualization model configured to generate, based on one or more of the plurality of metrics, a visualization of the microservice system.

5. The system of claim 4, wherein the visualization represents each microservice of the plurality of microservices as a node, and wherein the visualization comprises an interactive three-dimensional visualization that enables selecting a particular node and highlighting nodes that are invoked by the particular node.

6. The system of claim 4, wherein the visualization comprises a color-coding scheme that differentiates microservices based on their number of dependencies compared to a predefined value.

7. The system of claim 4, wherein the visualization comprises a hierarchical visual model that enables navigation from a current visual model that gives a system-level view to one or more detailed application-level views.

8. The system of claim 1, wherein the second version of the source code comprises at least one new module or remote call that is absent from the first version of the source code, and wherein the output comprising the analysis is generated prior to compiling the second version of the source code.

9. A method of tracking an evolution of a microservice system that includes a plurality of microservices, comprising:
generating, based on an analysis of a source code of the microservice system, an intermediate representation associated with a service view or a data model view of the microservice system;
determining, based on the intermediate representation, a first set of values for a plurality of metrics associated with a first version of the source code;
determining, based on the intermediate representation, a second set of values for the plurality of metrics associated with a second version of the source code; and
generating, based on comparing the first set of values and the second set of values, an output comprising an analysis of one or more architectural changes in the microservice system.

10. The method of claim 9, wherein the intermediate representation comprises a component call graph (CCG) for at least one microservice of the plurality of microservices, and wherein the CCG is rooted with an endpoint of the at least one microservice.

11. The method of claim 9, wherein the plurality of metrics comprise at least one of:
a number of the plurality of microservices in the microservice system;
a number of microservices connections in the microservice system;
a number of persistent data entities in the microservice system;
a number of transient data entities in the microservice system;
a number of data relationships between data entities in the microservice system;
a number of candidate data entities in the microservice system for merging; or
a number of candidate data relationships between data entities in the microservice system for merging.

12. The method of claim 9, further comprising:
generating, based on one or more of the plurality of metrics, a visualization of the microservice system.

13. The method of claim 12, wherein the visualization represents each microservice of the plurality of microservices as a node, and wherein the visualization comprises an interactive three-dimensional visualization that enables selecting a particular node and highlighting nodes that are invoked by the particular node.

14. The method of claim 12, wherein the visualization comprises a color-coding scheme that differentiates microservices based on their number of dependencies compared to a predefined value.

15. The method of claim 12, wherein the visualization comprises a hierarchical visual model that enables navigation from a current visual model that gives a system-level view to one or more detailed application-level views.

16. The method of claim 9, wherein the second version of the source code comprises at least one new module or remote call that is absent from the first version of the source code, and wherein the output comprising the analysis is generated prior to compiling the second version of the source code.

17. A non-transitory computer-readable storage medium having instructions stored thereupon for tracking an evolution of a microservice system that includes a plurality of microservices, comprising:
instructions for generating, based on an analysis of a source code of the microservice system, an intermediate representation associated with a service view or a data model view of the microservice system;
instructions for determining, based on the intermediate representation, a first set of values for a plurality of metrics associated with a first version of the source code;
instructions for determining, based on the intermediate representation, a second set of values for the plurality of metrics associated with a second version of the source code; and
instructions for generating, based on comparing the first set of values and the second set of values, an output comprising an analysis of one or more architectural changes in the microservice system.

18. The non-transitory computer-readable storage medium of claim 17, wherein the intermediate representation comprises a component call graph (CCG) for at least one microservice of the plurality of microservices, wherein the CCG is rooted with an endpoint of the at least one microservice, and wherein the plurality of metrics comprise at least one of:
a number of the plurality of microservices in the microservice system;
a number of microservices connections in the microservice system;
a number of persistent data entities in the microservice system;
a number of transient data entities in the microservice system;
a number of data relationships between data entities in the microservice system;
a number of candidate data entities in the microservice system for merging; or
a number of candidate data relationships between data entities in the microservice system for merging.

19. The non-transitory computer-readable storage medium of claim 17, comprising:
instructions for generating, based on one or more of the plurality of metrics, a visualization of the microservice system.

20. The non-transitory computer-readable storage medium of claim 17, wherein the second version of the source code comprises at least one new module or remote call that is absent from the first version of the source code, and wherein the output comprising the analysis is generated prior to compiling the second version of the source code.
